(19) United States
(12) Patent Application Publication
(10) Pub. No.: US 2023/0033331 A1
(43) Pub. Date: Feb. 2, 2023

(54) LIGHTING ARRANGEMENT FOR ILLUMINATION WITH AN ANGLE WHICH DEPENDS ON A DISTANCE BETWEEN PLANT CONTAINERS

(71) Applicant: SIGNIFY HOLDING B.V., EINDHOVEN (NL)

(72) Inventors: Bartel Marinus VAN DE SLUIS, EINDHOVEN (NL); Rob Franciscus Maria VAN ELMPT, EINDHOVEN (NL); Marcellinus Petrus Carolus Michael KRIJN, EINDHOVEN (NL)

(21) Appl. No.: 17/788,316

(22) PCT Filed: Dec. 21, 2020
(86) PCT No.: PCT/EP2020/087496

§ 371 Date: Jun. 23, 2022

(30) Foreign Application Priority Data
Jan. 2, 2020 (EP) 20150070.9

(51) Int. Cl. A01G 9/24; H05B 47/105

(52) U.S. Cl. CPC A01G 9/249; H05B 47/105

(57) ABSTRACT

A lighting arrangement (1) for use in a plant growing environment comprises a light source (5). The plant growing environment comprises at least a first plant container (11) and a second plant container (12) adapted to move relative to each other. The light source is arranged to illuminate a plant from below when the plant is provided in the first plant container. An angle of the illumination depends on a distance between the first plant container and the second plant container.

### FIELD OF THE INVENTION

The invention relates to a lighting arrangement for use in a plant growing environment, said plant growing environment comprising at least a first plant container and a second plant container.

The invention further relates to a computer-implemented method of illuminating a plant in a first plant container in a plant growing environment, said plant growing environment comprising at least said first plant container and a second plant container.

The invention also relates to a computer program product enabling a computer system to perform such methods.

### BACKGROUND OF THE INVENTION

Growing of crops in greenhouses has been common practice for a long time. For the photosynthesis of the plants, the sun is being used as a main source of light. In recent years the dark periods of the day have been filled in with artificial lighting, to boost the growth of the crops. First HID lamps were used. The HID lamps are in the process of being replaced by LED. Advantages of LED are the capability to spectrally tune the LEDs according to the plants and humans desire, the higher efficacy of LED as compared to HID, and the fact that they can be instantaneously dimmed or boosted.

One of the issues in horticulture lighting is that when plants reach a certain size, their leaves prevent light from above, e.g. top-lighting, to reach the lower parts of the plant, accelerating leaf senescence in the bottom leaves due to shading by the upper leaves and by neighboring plants, thereby reducing the quality and economic value of the plants.

Solutions exist to illuminate the lower parts of plants with inter-lighting, i.e. lighting devices hanging between the plants. However, when plants are moved (for harvesting, or for “plant respacing”), those devices may damage the plants. In a farm with a linear continuous process where plant containers move through the factory, there is even more chance that inter-lighting devices damage the plants.

Light-emitting plant pots, and spike spotlights to illuminate garden plants/trees from below are also known. For example, JP2015092861A discloses an arrangement wherein the plant is surrounded by LEDs arranged at the top, LEDs arranged at the sides and LEDs arranged near the bottom. Each attachment angle is configured to be adjustable so that light can be irradiated to the crop at an arbitrary angle. A drawback of the arrangement of JP2015092861A is that a plant grower regularly needs to adjust the attachment angle to illuminate the lower parts of plants sufficiently, thereby taking the plant grower substantial effort.

### SUMMARY OF THE INVENTION

It is a first object of the invention to provide a lighting arrangement, which can be used to sufficiently illuminate the lower parts of plants without requiring substantial effort by the plant grower.

It is a second object of the invention to provide a method, which can be used to sufficiently illuminate the lower parts of plants without requiring substantial effort by the plant grower.

In a first aspect of the invention, a lighting arrangement for use in a plant growing environment, said plant growing environment comprising at least a first plant container and a second plant container adapted to move relative to each other, comprises a light source arranged to illuminate a plant from below when said plant is provided in said first plant container, wherein an angle of said illumination of said plant depends on a distance between said first plant container and said second plant container. Lighting arrangements to illuminate plants from below are often also referred to as bottom lighting.

As the plants in a plant growing environment grow, the distance between the plant containers is normally increased as well (to accommodate the increased size of the plants). The plant containers are therefore adapted to move relative to each other during the growth process of the plants to accommodate for increased plant size. By illuminating a plant from below with an angle of illumination that depends on a distance between the plant containers, more or less or different lower parts of the plant are illuminated during the growth of the plant without requiring substantial effort by the plant grower. The inventors have recognized that there is a relation between the distance between neighboring plant containers and a beneficial illumination angle. In preferred examples, the angle of illumination of the plant changes from a more horizontal illumination (i.e. having a larger horizontal component than a vertical component) towards more vertical illumination (i.e. having a larger vertical component than a horizontal component) as the distance between neighboring plant containers increases.

Said lighting arrangement may further comprise at least one of a chargeable battery, a power connector, a sliding contact, energy-harvesting means and a wireless power receiver for powering the light source. Said energy-harvesting means may comprise a photovoltaic cell, for example.

Said lighting arrangement may further comprise a first base plate, a second base plate coupled to said first base plate via a hinge, first attachment means for attaching said first base plate to said first plant container, and second attachment means for attaching said second base plate to said second plant container, wherein said light source has been mounted on said first base plate. This allows the light arrangement to be made such that the light source is relatively close to the plant in the first plant container when the distance between neighboring plant containers is relatively small.

Said lighting arrangement may further comprise a further light source mounted on said second base plate, said further light source being arranged to illuminate a further plant provided in said second plant container under different angles of illumination. This ensures that plants in both neighboring plant containers are illuminated.

Said first base plate and said second base plate may be adapted to reflect lighting coming from above. This helps make the lighting arrangement more efficient, because some of the light from the top lighting that would otherwise be wasted may be reflected.

Said lighting arrangement may be attached to or embedded in said second plant container. By using a light source attached to or embedded in a plant container to illuminate a plant in a neighboring plant container, the angle of illumination is made dependent on distance even without mechanical or digital means to (re-)direct the light.

In the lighting arrangements disclosed above, the lighting arrangements are adapted to be mechanically coupled to at least one of the first plant container and the second plant container.

Said lighting arrangement may comprise a controller configured to determine a distance between said first and second plant containers and control an angle of illumination and/or an angle of emission of said light source based on said distance. The allows the angle of illumination or angle of emission to be optimized based on the distance. The distance may be measured using an infrared or ultrasonic sensor, for example. An angle of emission typically takes as a reference the light source, whereas an angle of illumination typically takes as a reference the plant itself or a plant part thereof.

Said controller may be configured to control a color and/or intensity of said light source based on said determined distance. While the color and/or intensity of grow light typically depends on the growth stage, it may be easier to determine the color and/or intensity based on the determined distance, as the distance between plant containers provides an indication of the current growth stage. In this case, it is not necessary to determine the growth stage first. The light output level of the light source may need to be increased as the distance becomes larger.

Said lighting arrangement may comprise a controller configured to determine a growth stage of said plant and control a color and/or intensity of said light source based on said growth stage of said plant. Alternatively, said lighting arrangement may comprise a controller configured to determine a growth stage of a further plant in said second plant container and control a color and/or intensity of said light source based on said growth stage of said further plant. As the color and/or intensity of grow light typically depends on the growth stage, color and/or intensity settings may be associated with growth stages in a light protocol or growth protocol. As different plant types may require with different color and/or intensity settings, the color and/or intensity settings for the plant being illuminated may be used. However, in plant growing environments neighboring plants are often of the same type and species and therefore, if the light arrangement for illuminating the plant in the first plant container is embedded in or attached to the second plant container, it may be easier to use the color and/or light settings for the further plant provided in the second plant container to control the illumination of the plant provided in the first plant container. It may then be assumed that the first plant container is provided with the same plant type and species as the second plant container.

Said controller may be configured to determine a distance between said first and second plant containers and determine said growth stage based on said distance. This may be an easy way to determine or at least estimate the growth stage, as the distance between plant containers provides an indication of the current growth stage. The distance may be measured using an infrared or ultrasonic sensor, for example.

Said controller may be configured to determine a distance between said first and second plant containers and determine or at least estimate a size of said plant based on said distance. The distance may be measured using an infrared or ultrasonic sensor, for example. The angle of illumination of said plant, thereby illuminating more or less or different lower parts of said plant may then depend on the determined or estimated size of said plant.

In a second aspect of the invention, a plant growing arrangement comprises said lighting arrangement and said first and second plant containers. Said first and second plant containers may be plant trays, plant gullies or plant pots, for example.

In a third aspect of the invention, a computer-implemented method of illuminating a plant in a first plant container in a plant growing environment, said plant growing environment comprising at least said first plant container and a second plant container, comprises determining a distance between said first and second plant containers, determining an angle of illumination based on said distance, and illuminating said plant from below at said angle with a light source associated with said second plant container. Said method may be performed by software running on a programmable device, e.g., the controller as described above. This software may be provided as a computer program product.

Moreover, a computer program for carrying out the methods described herein, as well as a non-transitory computer readable storage-medium storing the computer program are provided. A computer program may, for example, be downloaded by or uploaded to an existing device, e.g., the controller as described above, or be stored upon manufacturing of these systems, e.g., the lighting arrangement as described above.

A non-transitory computer-readable storage medium stores at least a software code portion, the software code portion, when executed or processed by a computer, e.g., the controller described above, being configured to perform executable operations for illuminating a plant in a first plant container in a plant growing environment, said plant growing environment comprising at least said first plant container and a second plant container.

The executable operations comprise determining a distance between said first and second plant containers, determining an angle of illumination based on said distance, and illuminating said plant from below at said angle with a light source associated with said second plant container.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the lighting arrangement;

FIG. 2 provides a first example of how an angle of illumination depends on a distance between plant containers;

FIG. 3 is a block diagram of a second embodiment of the lighting arrangement;

FIG. 4 is a block diagram of a third embodiment of the lighting arrangement;

FIG. 5 provides a second example of how an angle of illumination depends on a distance between plant containers;

FIG. 6 is a flow diagram of a first embodiment of the method;

FIG. 7 is a flow diagram of a second embodiment of the method;

FIG. 8 is a flow diagram of a third embodiment of the method; and

FIG. 9 is a block diagram of an exemplary data processing system for performing the method of the invention.

Corresponding elements in the drawings are denoted by the same reference numeral.

### DETAILED DESCRIPTION OF THE EMBODIMENTS

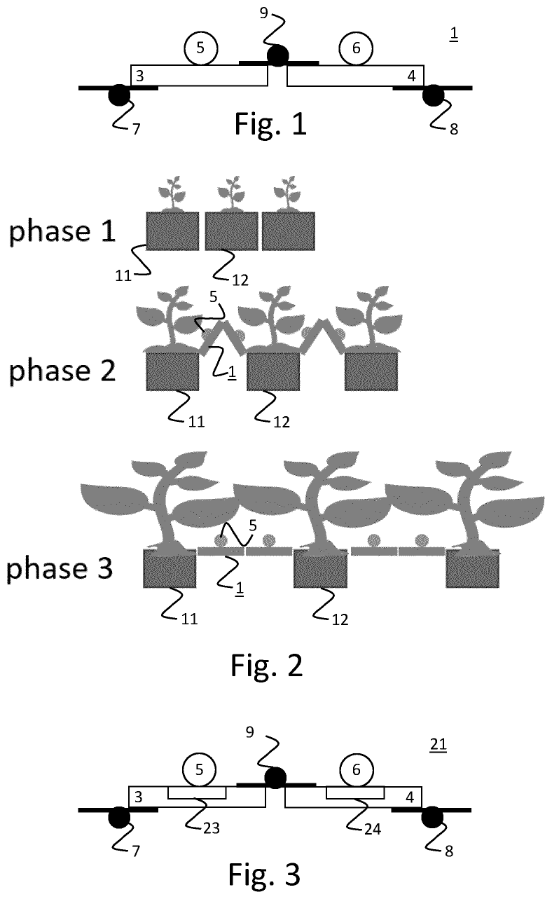

FIG. 1 shows a first embodiment of the lighting arrangement for use in a plant growing environment: lighting arrangement 1. The plant growing environment comprising at least a first plant container and a second plant container. The first and second plant containers may be plant trays, plant gullies or plant pots, for example. The lighting arrangement 1 comprises a light source 5 arranged to illuminate a plant from below when the plant is provided in the first plant container. The angle of the illumination depends on a distance between the first plant container and the second plant container.

In the embodiment of FIG. 1, the lighting arrangement 1 further comprises, in addition to the light source 5, a first base plate 3 and a second base plate 4 coupled to the first base plate via a hinge 9. The light source 5 has been mounted on the first base plate 3. The lighting arrangement 1 also comprises first attachment means 7, e.g. a second hinge, for attaching the first base plate 3 to the first plant container and second attachment means 8, e.g. a third hinge, for attaching the second base plate 4 to the second plant container. Thus, the lighting arrangement 1 is an unfolding structure comprising two linear sub modules that hinge.

In the embodiment of FIG. 1, the lighting arrangement comprises a further light source 6 mounted on the second base plate 4. The further light source 6 is arranged to illuminate a further plant provided in the second plant container under different angles of illumination. The light source 5 and the further light source 6 may be LEDs, for example.

The light arrangement may comprise at least one of a chargeable battery, a power connector, a sliding contact and a wireless power receiver for powering the light source. This is not shown in FIG. 1. It is beneficial to adapt the first base plate 3 and the second base plate 4 to reflect lighting coming from above. Preferably, only the areas where the light sources 5 and 6 are positioned are not reflective.

FIG. 2 provides a first example of how an angle of illumination depends on a distance between plant containers. FIG. 2 depicts an example of a mobile gully system. A mobile gully system is a system of mobile plant gullies which can be automatically moved relative to each other in order to adjust the desired spacing between adjacent gullies to the sizes of the plants provided in said gullies. The mobile gully system of FIG. 2 has linear mechanical guides which move the plant gullies if needed. The gullies, including gullies 11 and 12, are moving from left to right or vice versa on top of a track/rail system.

Linear hinging base lighting elements, i.e. lightings element configured like lighting arrangement 1 of FIG. 1, are positioned between the plant gullies. This is beneficial, because gullies are positioned directly adjacent without space in between when crops are small (phase 1). In that phase, no base lighting is needed as all light needed for the plants to grow will be provided by top lighting above the plants. In an embodiment (not shown) the lighting arrangement may be already available in this phase (phase 1), i.e. already mechanically coupled to plant containers, but not emitting light. In this case the angle between the two base plates would be close to 0° (hinge 9 almost closed) and light sources 5 and 6 being positioned for emitting substantially horizontal light. However, in this phase light emission from light sources 5 and 6 may not be needed (see above). With the crops growing (phases 2 and 3), space is created between the gullies, allowing positioning of a narrow linear lighting module.

Since the lighting arrangement 1 is an unfolding structure comprising two base plates that hinge, when gullies are close to each other, the angle between the two base plates is <45° and the light is directed more horizontally towards the crops (phase 2). With increasing gully distances, the angle becomes larger, up to 180° in fully stretched position. The light is now directing upward, lighting the bottom part of the leaves (phase 3). The light source 5 of the lighting arrangement 1 placed between gullies 11 and 12 illuminates the plants provided in gully 11. The light source 5 may be a light strip, for example.

Normally, light coming from top lighting above the plants would be lost between the gullies, but as previously described, the lighting arrangement 1 could also function as a white/reflective gap filler to enable better re-use of top light. The lighting arrangement 1 is attached to the top of the plant gullies. In another embodiment, the lighting arrangement is attached to the bottom of the plant gullies.

FIG. 3 shows a second embodiment of the lighting arrangement for use in a plant growing environment: lighting arrangement 21. Lighting arrangement 21 is variation of lighting arrangement 1 of FIG. 1. Compared to lighting arrangement 1, lighting arrangement 21 further comprises a controller 23 configured to determine a growth stage of the plant provided in the first container or of the further plant provided in the second container and control a color and/or intensity of the light source 5 based on this growth stage. For example, light from the light source 5 may only be activated when a certain plant size is detected, or the plant size is expected to exceed a pre-defined size.

The controller 23 may be configured to determine a distance between the first and second plant containers and determine or estimate the growth stage based on the distance. Color and/or intensity settings may be associated with growth stages in a light protocol or growth protocol. The lighting arrangement 21 may receive (part of) this protocol via a wireless signal. This is not shown in FIG. 3. In an alternative embodiment, the lighting arrangement receives control signals via a control bus or via a wireless signal. Lighting arrangement 21 further comprises a controller 24, which is configured in the same way as controller 23, but which controls light source 6 instead of light source 5.

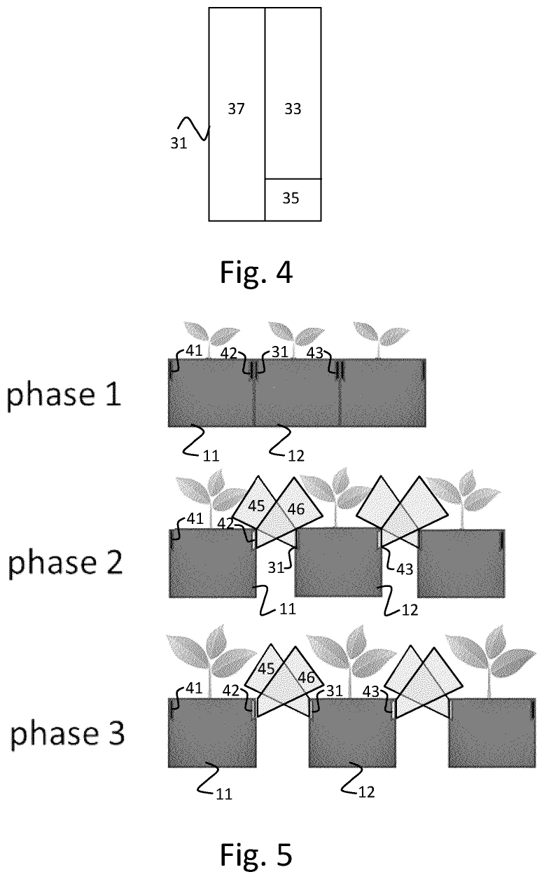

FIG. 4 shows a block diagram of third embodiment of the lighting arrangement, referred to as lighting arrangement 31, for use in a plant growing environment. The plant growing environment comprising at least a first plant container and a second plant container. The lighting arrangement 31 comprises a light source 37 arranged to illuminate a plant from below when the plant is provided in the first plant container. The angle of the illumination depends on a distance between the first plant container and the second plant container.

In the embodiment of FIG. 4, the lighting arrangement 31 further comprises a controller 33. The controller 33 may be configured to determine a distance between the first and second plant containers and control an angle of illumination and/or an angle of emission of the light source 37 based on the distance. An angle of emission typically takes as a reference the light source (e.g. the normal to the plane of the light source), whereas an angle of illumination typically takes as a reference the plant itself (e.g. being illuminated from the bottom/side/top) or a plant part thereof (e.g. an angle relative to the plant stem). The distance may be measured using an infrared or ultrasonic sensor (not shown in FIG. 4), for example. Alternatively or additionally, the controller 33 may be configured to determine a growth stage of the plant provided in the first container or of the further plant provided in the second container and control a color and/or intensity of the light source based on this growth stage.

In the embodiment of FIG. 4, the lighting arrangement 31 further comprises a chargeable battery 35. The lighting arrangement 31 may further comprise a power connector, a sliding contact, energy-harvesting means or a wireless power receiver for powering the light source 37. The energy-harvesting means may comprise a photovoltaic cell, for example. For instance, the base plates 3 and 4 as described above may comprise both the light source(s) and the photovoltaic cell(s). In an alternative embodiment, the lighting arrangement 31 does not comprise a chargeable battery 35.

FIG. 5 provides another example of how an angle of illumination depends on a distance between plant containers. In the example of FIG. 5, the lighting arrangement 31 is embedded in the second plant container, i.e. plant gully 12. The lighting arrangements 41-43 are the same as the lighting arrangement 31. The lighting arrangements 31,41-43 are integrated in the linear sides of the plant gullies 11 and 12. In an alternative embodiment, the lighting arrangement 31 is attached to the second plant container. e.g. attached to a linear side of the plant gully 12. In the example of FIG. 5, the light source(s) 37 of lighting arrangements 31, 41-43 are equipped with optical elements which direct the lights upwards, in the direction of neighboring plants.

The light source(s) 37 may further be controlled by controller(s) 33 of lighting arrangement(s) 31, 41-43 based on the presence of and/or distance to a neighboring gully. When the plant gullies are directly adjacent, the light source(s) 37 are switched off. However, when the plant gullies are further apart (and plants are larger), the light source(s) 37 is activated. Without such a distance-dependent activation, the closer the containers are to each other, the more they obstruct each other's light beams, ultimately completely obstructing each other's light beam when next to each other. In a more advanced embodiment, the color and/or intensity and/or beam angle may be adjusted based on the distance between the plant gullies, and/or received input about the (expected/detected) current sizes/growth stages of the neighboring plants.

Power may be provided to the lighting sources in various ways. In the case of the plant tray being moved along a linear continuous plant growing process, it may use a sliding contact or have a wireless power transfer means, located at each position where the plant container is supposed to be located for a longer period of time, possibly in combination with a chargeable battery to ensure light protocol continuity when power transfer should be temporarily interrupted. A chargeable battery 35 may be included in each the lighting arrangement 31, 41-43. Alternatively, the lighting arrangements may simply be connected via a power cable or have a powerful (chargeable) integrated battery.

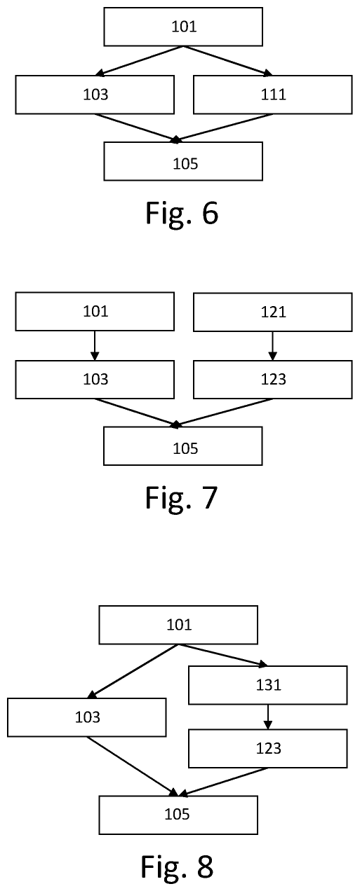

A first embodiment of the computer-implemented method of illuminating a plant in a first plant container in a plant growing environment is shown in FIG. 6. The plant growing environment comprises at least the first plant container and a second plant container. A step 101 comprises determining a distance between the first and second plant containers.

A step 103 comprises determining an angle of illumination based on the distance determined in step 101. In the embodiment of FIG. 6, a step 111 is performed in parallel with step 103. Step 111 comprises determining a color and/or intensity for the light source based on the distance determined in step 101. In the embodiment of FIG. 6, step 111 is performed at least partly in parallel with step 103. In an alternative embodiment, step 111 is performed before or after step 103.

A step 105 comprises illuminating the plant in the first plant container from below using the color and/or intensity determined in step 111 and at the angle determined in step 103, with a light source associated with the second plant container.

A second embodiment of the computer-implemented method of illuminating a plant in a first plant container in a plant growing environment is shown in FIG. 7. Like in the first embodiment, step 101 comprises determining a distance between the first and second plant containers and step 103 comprises determining an angle of illumination based on this distance.

In the embodiment of FIG. 7, steps 121 and 123 are performed in parallel with steps 101 and 103. Step 121 comprises determining a growth stage of the plant provided in the first container or of a further plant provided in the second container. Step 123 comprises determining a color and/or intensity for the light source based on the growth stage determined in step 121.

Step 105 comprises illuminating the plant in the first plant container from below using the color and/or intensity determined in step 123 and at the angle determined in step 103, with a light source associated with the second plant container.

A third embodiment of the computer-implemented method of illuminating a plant in a first plant container in a plant growing environment is shown in FIG. 8. Like in the first embodiment, step 101 comprises determining a distance between the first and second plant containers and step 103 comprises determining an angle of illumination based on this distance.

Steps 131 and 123 are performed in parallel with step 103. Step 131 comprises determine a growth stage based on the distance determined in step 101. Like in the second embodiment, step 123 comprises determining a color and/or intensity for the light source based on the determined growth stage (determined in step 131).

Like in the second embodiment, step 105 comprises illuminating the plant in the first plant container from below using the color and/or intensity determined in step 123 and at the angle determined in step 103, with a light source associated with the second plant container.

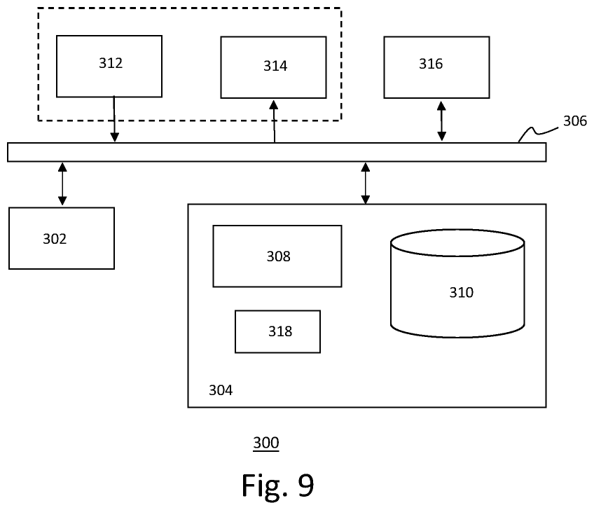

FIG. 9 depicts a block diagram illustrating an exemplary data processing system that may perform the method as described with reference to FIGS. 6 to 8.

As shown in FIG. 9, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 9, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 9) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A plant growing arrangement for use in a plant growing environment, said plant growing arrangement comprising:
at least a first plant container and a second plant container adapted to move relative to each other during the growth process of plants in said plant growing arrangement;
a lighting arrangement comprising:
a light source arranged to illuminate the plant from below when said plant is provided in said first plant container, wherein the Sighting arrangement is adapted to be mechanically coupled to at least one or the first plant, container and the second plant container, and wherein an angle of said illumination is dependent depends on a distance between said first plant container and said second plant container.

2. The plant growing arrangement as claimed in claim 1, the lighting arrangement further comprising:
a first base plate;
a second base plate coupled to said first base plate via a hinge;
first attachment means for attaching said first base plate to said first plant container; and
second attachment means for attaching said second base plate to said second plant container,
wherein said light source has been mounted on said first base plate.

3. The plant growing arrangement as claimed in claim 2, the lighting arrangement further comprising a further light source mounted on said second base plate said further light source being arranged to illuminate a further plant provided in said second plant container under different angles of illumination.

4. The plant growing arrangement as claimed in claim 2, wherein said first base plate and said second base plate are adapted to reflect lighting coming from above.

5. The plant growing arrangement as claimed in claim 1, wherein said lighting arrangement is attached to or embedded in said second plant container.

6. The plant growing arrangement as claimed in claim 1, said lighting arrangement) comprising a controllers configured to determine a distance between said first and second plant containers and control an angle of illumination and/or an angle of emission of said light source based on said distance.

7. The plant growing arrangement as claimed in claim 6, wherein said controllers is configured to control a color and/or intensity of said light source based on said determined distance.

8. The plant growing arrangement as claimed in claim 1, the lighting arrangement comprising a controller configured to determine a growth stage of said plant and control a color and/or intensity of said light source based on said growth stage of said plant.

9. The plant growing arrangement as claimed in claim 1, the lighting arrangement comprising a controller configured to determine a growth stage of a further plant and control a color and/or intensity of said light source based on said growth stage of said further plant, said further plant being provided in said second container.

10. The plant growing arrangement as claimed in claim 8, wherein said controller is configured to determine a distance between said first and second plant containers and determine said growth stage based on said distance.

11. The plant growing arrangement as claimed in claim 1, the lighting arrangement further comprising at least one of a chargeable battery, a power connector, a sliding contact, energy-harvesting means and a wireless power receiver for powering the light source.

12. (canceled)

13. The plant growing arrangement as claimed in claim 1, wherein said first and second plant containers are plant trays, plant gullies or plant pots.

14. A computer-implemented method of illuminating a plant in a first plant container in a plant growing environment, said plant growing environment comprising at least said first plant container and a second plant container, said method comprising:
determining a distance between said first and second plant containers;
determining an angle of illumination based on said distance; and
illuminating said plant from below at said angle with a light source associated with said second plant container.

15. A non-transitory computer readable medium comprising instructions, the instructions, when executed by a computer system, cause the computer system to perform the method of claim 14.

16. The computer-implemented method as claimed in claim 14, comprising determining a growth stage of said plant and control a color and/or intensity of said light source based on said growth stage of said plant.
